(19) United States
(12) Patent Application Publication
(10) Pub. No.: US 2002/0141135 A1
(43) Pub. Date: Oct. 3, 2002

(54) CAPACITOR DIELECTRIC FLUID

(76) Inventors: Dennis R. Henderson, Indianapolis, IN (US); Christopher M. Baldwin, Indianapolis, IN (US)

Correspondence Address: Robert F. Meyer, North American Capacitor Company, 7545 Rockville Road, Indianapolis, IN, 46214, US

(21) Appl. No.: 09/821,363

(22) Filed: Mar. 30, 2001

(51) Int. Cl. H01G 4/32

(52) U.S. Cl. 361/301.5

(57) ABSTRACT

A dielectric fluid of refined soybean oil with additives of cycloaliphatic epoxide resin and butylated hydroxtolene covered in the winding of a metallized polypropylene film capacitor to prevent trapped air and moisture being absorbed in the winding.

### BACKGROUND OF INVENTION

This invention relates to dielectric fluids for electrical capacitors, particularly metallized polypropylene film capacitors.

In the manufacture of metallized film capacitors, the selection of the dielectric fluid has a substantial influence on the electrical characteristics of the capacitor. The fluid is needed to prevent trapped air and moisture from absorbing into the winding of the metallized film and eroding away the metallized layer by electrical discharge.

The dielectric fluid needs to have a low moisture content (less than 600 ppm), a dielectric constant similar to polypropylene which has a dielectric constant of 3, additives to scavenger acidic contaminates, and have low absorption by propropylene film.

### SUMMARY OF THE INVENTION

Accordingly, the present invention resides in a capacitor wherein a dielectric fluid consists essentially of refined soybean oil, and additives of cycloaliphatic epoxide resin and butylated hydroxytoluene.

### BRIEF DESCRIPTION OF THE DRAWINGS

The present invention is illustratively shown and described in respect to the accompanying drawings in which:

FIG. 1 is a perspective view of a convolutely wound metallized film capacitor body which is partially unwound to show the dielectric plastic film and metallized foil electrode structure;

FIG. 2 is a perspective view of the capacitor body of FIG. 1 to which terminal leads are attached;

FIG. 3 is a partial sectional view taken across lines 3-3 of FIG. 1; and

FIG. 4 is a perspective view of the capacitor body of FIGS. 1 and 2 enclosed in a suitable housing.

### DETAILED DESCRIPTION OF THE INVENTION

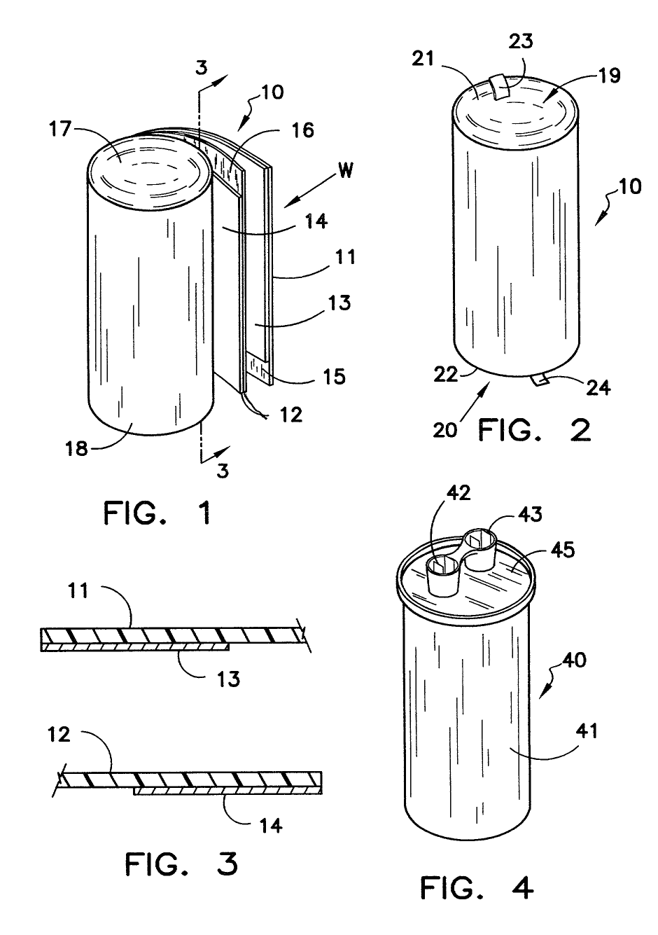

Referring now to FIG. 1, there is illustrated a convolutely wound ac capacitor body 10. The capacitor body 10 includes a pair of dielectric plastic film layers 11 and 12 and overlying metallized electrodes 13 and 14, respectively providing a winding W. The dielectric plastic film layers 11 and 12 are metallized in such a manner so as to provide margins 15 and 16 which are free of metal. Such margins are useful in helping to prevent electrical short circuits between the metallized electrodes at the ends of the capacitor body 10. In convolutely winding the capacitor body 10, the metallized electrode 13 overlying the plastic film 11 is laterally offset with respect to the metallized electrode 14 overlying the plastic film 12 so that metallized electrode 13 and margin 16 appear at end 17 of the capacitor body so that metallized electrode 14 and margin 15 appear at end 18 of the capacitor body.

As shown in FIG. 2, suitable terminal leads 19 and 20 are attached to the ends 17 and 18, respectively, of the capacitor body 10 using any suitable attachment process. The attachment process must not result in electrically conductive material penetrating into the capacitor body 10 to cause the metallized electrode at the capacitor body edge to electrically short the other metallized electrode. An acceptable attachment process includes spraying the ends 17 and 18 of the capacitor body 10 with lead, a lead alloy, aluminum, an aluminum alloy, zinc, a zinc alloy, tin, a tin alloy, nickel, a nickel alloy and the like. The metal material at the ends of the capacitor body 10 are indicated by the reference numerals 21 and 22. Lead strips 23 and 24 are suitably attached to the metal material as shown in FIG. 2. A suitable lead strip material is solder coated copper.

FIG. 3 is a sectional view taken along the line 3-3 of FIG. 1 but limited to a small section of the capacitor body 10. In FIG. 3, the plastic film layers 11 and 12 and their respective overlying metallized electrodes 13 and 14 are arranged in the same manner as shown in FIG. 1.

Metallized electrode 13 is integrally joined to the plastic film 11 whereas metallized electrode 14 is integrally joined to the plastic film 12. FIG. 3 shows a metallized electrode on but one side of the plastic film; however, the metallized electrode layers may be deposited on both sides of the plastic film. FIG. 3 shows a single side of the plastic film as being metallized. The application of the metallized electrodes 13 and 14 to their respective plastic film may be accomplished by any suitable process such as vapor, chemical or other known metal depostion processes.

The dielectric plastic films or layers 11 and 12 should have high dielectric strength, low dissipation factor to prevent thermal runaway, broad temperature range capabilities, resistance to the dielectric fluid, and freedom from pinholes and conductive particles. The electric film layers 11 and 12 may be of any suitable homogenous polymer or plastic material such as polyester, poylethylene, polycarbonate, polystyrene, polysulfone, polyethylene terephthalate and, preferably, the polyoefins, particularly polypropylene.

In FIG. 4, a capacitor body 10 is preferably sealed in a can or housing 40 to form a capacitor 41. Capacitor 41 includes the metal housing or can 40 and terminals 42 and 43. The capacitor body 10 is contained within the housing 40 and terminal lead 23 makes electrical contact with terminal 42 and the remaining terminal lead 24 makes electrical contact with terminal 43. The housing is sealed through lid 45.

The dielectric fluid of the present invention consists essentially of refined soybean oil and additives of cycloaliphatic epoxide resin and butylated hydroxytoluene. The refined soybean is in amount of 98.9% by volume while the epoxide is in an amount of 1.0% by volume and the epoxide acts as a seavenger of acidic contaminants while the hydroxytoluene to acts as an antioxidant. The hydroxytoluene in amount of 0.1% by volume. The term “refined soybean oil” is meant to mean a fully refined 100% soybean salad oil which has been refined, bleached, and deordorized in a continuous and totally integrated process.

The dielectric fluid is incorporated in the metallized film capacitor by dispensing the fluid into an open end of can 41 until the winding W is completely covered.

What is claimed is:

1. In a capacitor, a dielectric fluid consisting essentially of refined soybean oil and a minor amount additives of cycloaliphatic epoxide resin and butylated hydroxytoluene.

2. In a capacitor according to claim 1 wherein said refined soybean oil is in an amount of 98.9% by volume.

3. In a capacitor according to claim 2 wherein said additives are in an amount of 1% and 0.9% by volume respectively.

4. A capacitor comprising:
A housing,
Convolutely wound metallized film electrodes enclosed within the housing, and
A dielectric liquid consisting essentially of 98.9 volume percent of refined soybean oil and additives of cycloaliphatic epoxide resin and butylated hydroxytoluene.
